(19) United States
(12) Patent Application Publication
(10) Pub. No.: US 2015/0339957 A1
(43) Pub. Date: Nov. 26, 2015

(54) Printed Product

(71) Applicant: Timonisam UG, Meerbusch (DE)

(72) Inventor: Timo Michalik, Meerbusch (DE)

(21) Appl. No.: 14/720,846

(22) Filed: May 25, 2015

(30) Foreign Application Priority Data
May 26, 2014 (EP) 14 169 903.3

(51) Int. Cl. G09F 3/10; B32B 27/32; B32B 27/30; B29C 65/78; B32B 38/00; B29C 59/00; B29C 65/76; B32B 27/06; B32B 37/20

(52) U.S. Cl. CPC G09F 3/10; B32B 27/06; B32B 27/32; B32B 27/304; B32B 37/203; B32B 38/0012; B32B 38/145; B29C 59/005; B29C 65/76; B29C 65/7888; G09F 2003/0232

(57) ABSTRACT

A printed product is provided with a plastic film of a polymer composition containing at least partially polyvinyl chloride or polyolefin. The plastic film has a first face and a second face. A printed layer made of at least one color medium is printed onto the first face of the plastic film, wherein the printed layer is sealant-free and forms a user-side exterior face of the printed product. The second face of the plastic film is connected by material fusion to a support. The support has a material thickness of at least 1.5 mm and is made at least partially of a foamed and recyclable polymer composition. The printed layer is printed onto the plastic film in a quantity of 5 ml/m² to 40 ml/m² of the at least one color medium. The printed product has a surface roughness of at least 10 μm at the printed side.

### BACKGROUND OF THE INVENTION

The invention relates to a printed product comprising a plastic film comprised of a polymer composition which at least partially comprises polyvinyl chloride (PVC) or polyolefin (PO), wherein the plastic film carries a printed layer of at least one color medium.

Printed products of the aforementioned kind are known in the prior art in particular in the form of adhesive labels; thus, no specific reference material explaining such products is required. Such adhesive printed products are primarily used for covering exposed surfaces such as walls, floors, furniture or the like. They serve primarily for individualizing the aforementioned surfaces and are used as advertising medium in particular in public spaces.

These adhesive labels known in the prior art have the disadvantage that they cannot be used, or can be used only to a limited extent, on uneven surfaces, for example, tiled surfaces, wood paneling, grid surfaces or the like, because they adopt the shape of the underlying surface and therefore distort the printed image in an undesirable way, in particular in edge areas of such surfaces. Moreover, such adhesive labels are particularly prone to be rubbed off or worn off in the aforementioned areas as a result of non-uniform force action. In particular in case of labels attached to floors, the labels are then no longer functional as advertising medium in a very short period of time.

Moreover, in connection with such adhesive labels there exists the technical problem that they must be removed from the surface to which they have been applied after having fulfilled their intended use. Due to the direct connection between adhesive and supporting (mounting) surface, removal is possible only with great expenditure. Moreover, the adhesive labels upon removal from the supporting (mounting) surface are in general destroyed and cannot be reused; this is problematic in particular with regard to ecological considerations and is no longer acceptable in view of the growing environmental concerns in the general public. In addition, the supporting (mounting) surface is also affected or damaged because residual adhesive material must be removed with aggressive cleaning agents. The service life of the supporting (mounting) surface is therefore reduced in an undesirable way. In addition to reducing the service life, possibly relevant surface properties, sound insulation properties, and/or fire protection properties of the supporting (mounting) surface are also reduced by attaching the adhesive printed product of the prior art in the form of an adhesive label; this may result in safety-relevant consequences.

It is therefore the object of the invention to provide, based on the above discussion, a printed product that avoids the afore described disadvantages of the printed product of the aforementioned kind.

### SUMMARY OF THE INVENTION

In accordance with the present invention, this is achieved in that the printed comprises a plastic film comprising a first face and an opposed second face and connected with the second face, that is without printed layer, onto a support in a material-fusing way, wherein the support has a material thickness of at least 1.5 mm and is comprised at least partially of foamed and recyclable polymer composition, and wherein the printed layer is printed with a quantity of 5 ml/m² to 40 ml/m² of at least one color medium onto the first face of the plastic film, wherein the printed product as a whole has a surface roughness at the printed side of the printed product of at least 10 μm. The printed layer is sealant-free and the printed layer forms the user-side exterior face of the printed product

According to the invention, the disadvantages of the prior art printed products are overcome in that the printed plastic film is no longer adhesively connected to the foreign supporting (mounting) surfaces, such as furniture surfaces, wall surfaces, and floors, but is already arranged on a support according to the invention, wherein the mechanical and thermal advantages, in comparison to conventional adhesive labels, are based on synergy effects, up to now unknown in the prior art, between the printed layer, the plastic film, and the support as well as their technical configuration.

The printed product according to the invention is comprised for this purpose of a plastic film which is connected by material fusion to a flexible and bendable support. Material fusion in the context of the invention refers in particular to an adhesive connection, fusing (welding) or the like. Advantageously, in this way an intimate connection between the plastic film and the support is realized and a detachment (separation) of the components from each other is prevented. In case of intended and proper use, the printed product due to its flexible and bendable components, in particular the support and the plastic film, is capable of compensating unevenness of the supporting (mounting) surface, in particular in case of brick walls, tiled floors, and the like. Advantageously, the visual uniformity of the printed pattern or image is thus always ensured, independent of the respective supporting (mounting) surface.

The support according to the invention is moreover capable of compensating mechanical loads occurring at the printed layer and ensures in this way, despite possible unevenness of the supporting (mounting) surface, a uniform force absorption and reduces in this way rubbing off and wear of the printed layer. Advantageously, in contrast to the prior art printed products, the intended and proper use of the printed product of the invention as an advertising medium is thus not impaired by the supporting (mounting) surface and/or mechanical action.

According to the invention, the support has for this purpose a material thickness of at least 1.5 mm. Preferred is a material thickness of 1.5 mm to 5 mm, further preferred of 1.6 mm to 3 mm, even more preferred of 1.6 mm to 2.0 mm, and particularly preferred 1.8 mm. It has been found that such a material thickness provides an optimized compromise between flexibility, weight, and force absorption capacity and heat absorption capacity. The thus obtainable flexibility enables in particular storage of the substrate and/or of the printed product in the form of rolls, preferably with the substrate/printed product dimensions of 4 m×30 m. In this way, a continuous printing action of the substrate is enabled and production is optimized with regard to efficiency.

The printed product according to the invention is moreover reusable because it must but not be adhesively connected to the supporting (mounting) surface for stationary arrangement; due to the foamed configuration of the support in combination with its composition according to the invention, the support ensures an anti-slip arrangement of the printed product at least on flat and slanted surfaces. Advantageously, destruction of the printed product and damage of the supporting (mounting) surface is thus completely avoided. For arrangement of the printed product on substantially vertical surface, the printed product has preferably suitable holding means for a suspended arrangement. Alternatively, the printed product can also be glued onto the supporting (mounting) surface in the way known in the prior art so that a particularly simple and stable connection with the vertical surface is formed. In accordance with this alternative fastening method, the printed product still provides the advantages according to the invention with regard to compensation of unevenness of the supporting (mounting) surface.

According to the invention, the support is comprised of a recyclable polymer composition. Preferably, for this purpose substantially exclusively recyclable components, such as in particular polyvinyl chloride, polystyrene, polyolefin and the like are used. Moreover, the recyclable composition may contain additives, plasticizers, pigments, fillers, in particular fibrous fillers, and stabilizers. The support according to the invention is therefore capable of being subjected to a recycling process and can be produced so as to save resources. Particularly preferred, the support is comprised of a biologically decomposable plastic material, in particular starch-based, lactic acid-based, cellulose-based or polyhydroxyalkanoate-based plastic materials, in particular polyhydroxybutyrate. By means of the employed biologically decomposable plastic materials, a minimum duration of use can be preferably adjusted and, subsequently, the product can be disposed of in an environmentally compatible way. In particular, in case of printed patterns with a temporally limited use, such as advertisement campaigns, this is greatly advantageous with regard to the large number of waste articles to be disposed of after fulfilled intended use.

According to the invention, the plastic film is formed of a polymer composition which at least partially comprises polyvinyl chloride, polyolefin or preferably polyolefin copolymers. The plastic film is thus mechanically extremely stable, resistant relative to wear, and also recyclable. Moreover, it is in particular optimally suitable as a substrate for receiving the printed layer because between the color medium according to the invention and the aforementioned materials a wear-resistant interaction is existing. The printed layer is thus protected by means of the plastic film at least partially against wear. Preferably, the plastic film has a material thickness of 0.1 mm to 0.4 mm, preferably 0.2 mm. In particular in combination with the material thickness of the support, a particularly flexible, mechanically stable printed product blank is provided that can be printed on to produce high quality prints.

According to a preferred embodiment of the invention, the plastic film is of a two-layer configuration and comprises at the side facing the support a fiber layer, in particular a glass fiber nonwoven, in order to advantageously increase the stability of the printed product. In particular when used on floors, where great forces are acting on the printed product, such a configuration is particularly advantageous. Moreover, the fiber layer, by reducing the heat expansion coefficient of the printed product, advantageously increases the shape stiffness of the printed product in case of temperature fluctuations; this is particularly advantageous when the printed product is used outdoors.

According to the invention, the printed product has a surface roughness at the printed layer side of at least 10 μm, preferably 10 μm to 30 μm, further preferred 13 μm to 20 μm. Surface roughness in the meaning of the invention refers to the distance between the average maximum height and the average minimum height of the surface. Advantageously, due to the surface roughness according to the invention, the printed product has comparatively good adhesive properties which are advantageous inter alia when walking on the printed product, in particular when the printed product is used as flooring, when arranging objects on the printed product, in particular when using the printed product as a table covering, or in case of sensory scanning of the printed product, in particular when using the printed product as a mouse pad. The surface roughness ensures in this respect an improved anti-slip safety when walking on the printed product and/or when placing objects on the printed product. In particular, anti-slip safety is provided on printed products that are dry, wet with water, moist with water, or oily or fatty.

This is in particular advantageous where there is a risk of wetting of the surface of the printed product with water or other liquids, in particular oil. For example, in a restaurant where a printed product according to the invention is used as a table covering, it may happen that drinks are spilled so that the printed product is wetted. Due to the surface roughness according to the invention even in case of such a wetted surface an advantageous anti-slip safety of the printed product is provided so that in particular glasses and the like can still be placed thereon without them slipping.

Moreover, the surface roughness provides for improved sensor precision when the printed product is used as a mouse pad due to the comparatively large surface area for scanning.

Preferably, the surface roughness is realized in that the plastic film and/or the support are formed with a relief structure at the printed side of the printed product. Relief structure in the meaning of the invention is to be understood in that the respective surface is provided with projections and depressions that are arranged in a regular or irregular pattern across the surface area, wherein a height difference of the projections and depressions is configured such that the printed product, even after printing of the plastic film with the printed layer, still has the aforementioned surface roughness.

According to the invention, the printed layer is printed on with a color medium quantity of 5 ml/m² to 40 ml/m², preferably 10 ml/m² to 30 ml/m², and further preferred 15 ml/m² to 20 ml/m². It has been found that such a color medium quantity, in particular in combination with the relief-type configuration of the plastic film, leads to the desired surface roughness without the image quality of the printed-on pattern or image being impaired.

Generally, different printing methods with different color media are suitable for printing on the plastic film. According to the invention, the printed layer is comprised of at least one color medium. In particular in case of black-and-white patterns or images, the use of a single color medium is sufficient so that the manufacture of the printed product is simplified. In particular in case of color patterns or images, it is however preferred to produce the printed layer with a color system of four color media, in particular blue, purple, yellow, and black also known as the CMYK (cyan, magenta, yellow, key) system. Preferably, the CMYK system, for improving the printed image, can be supplemented by two additional colors, in particular orange and green. Preferably, the at least one color medium or the respective color medium system is comprised of at least one UV-curable color medium that advantageously provides for fast curing, excellent printing quality, and a comparatively good wear resistance.

In addition to the aforementioned effects on the surface roughness, the quantity of the employed color medium is highly relevant with regard to thermal properties, in particular flammability of the printed product. It has been found that a color medium quantity of 5 ml to 40 ml, preferably 10 ml to 30 ml, further preferred 15 ml to 20 ml, per square meter, in combination with the thermal properties of the lower layers, contributes, in addition to the aforementioned advantages, to a reduced flammability of the printed product in comparison to the prior art. Preferably, the printed product can thus absorb a maximum heat quantity of at least 270 kJ, further preferred at least 480 kJ, per minute and per square meter without igniting. This is in particular advantageous where the printed product is exposed to excessive thermal loading. In contrast to the prior art, the printed product of the invention therefore provides a positive contribution to fire protection and thermal insulation and therefore can be used in areas where the use of prior art printed products is barred. In particular a maximum absorbable heat quantity of 480 kJ per square meter and minute permits use of the printed product in areas with high thermal loading as, for example, in case of supporting (mounting) surfaces that heat up greatly when exposed to intensive solar irradiation, such as, for example, asphalt, metal or the like.

According to a preferred embodiment of the invention, the printed layer forms the exterior side (side of use) of the printed product. Sealing of the printed layer is explicitly eliminated because it has been found that such a sealing action is disadvantageous with regard to representation of the printed image, to the recyclability, to the production expenditure, and to mechanical and thermal properties of the printed product according to the invention.

According to an alternative configuration of the invention, the printed layer comprises a sealing layer. Preferably, the sealing layer is connected with the remaining components by lamination. This is in particular advantageous when the printed product is exposed to significant mechanical loads, as those to be expected in case of excessive foot traffic or even vehicle traffic across the printed product, and the printed layer must be protected against premature wear. Preferably, the sealing layer for this purpose is formed of a wear-resistant and at the same time transparent material. Preferably, for this purpose thermoset plastic resins, in particular those that are based on polyurethane or phenyl, are used. Moreover, such a sealing action prevents possible migration of plasticizers that may occur in particular upon contact with vehicle wheels of rubber upon vehicle traffic across the printed product. An undesirable discoloration of the printed image which may be caused thereby is thus effectively prevented.

In addition to the aforementioned advantages, the individual components according to the invention provide for a comparatively simple, inexpensive, and highly individualized production of the printed product according to the invention.

For example, it is preferably provided that the support and the plastic film are produced in separate methods and as an intermediate product can be intermediately stored as a future substrate without loss of material quality. The support and the plastic film are preferably connected to each other by material fusion, in particular by adhesive connection or fusing (welding). The thus produced intermediate product forms a substrate which can be stored in a simple way and printed on. Preferably, the pre-manufactured substrate, after the client's order has been received, is formed to the printed product according to the invention in that it is printed with the desired pattern or image. Accordingly, it is possible to realize individual client's demands in a simple way.

According to a preferred embodiment of the invention, during the step of joining for forming the substrate, the plastic film and/or the support are provided with a relief structure for forming a surface roughness at the printed layer side of the printed product. Preferably, the relief structure is imparted to the plastic film and/or to the support by embossment with a suitable pressure-applying embossing mold and both are fused (welded) by pressure application to form the substrate at the same time. The substrate can thus be individually adjusted or adapted to any desired surface roughness. Moreover, with this method, if desired, the plastic film as well as the support can be provided with the relief structure in a common working step so that the manufacture of the printed product as a whole is simplified. Alternatively, the desired surface roughness can also be imparted by mechanical roughening by abrasion or the like to the substrate after the step of joining to form the substrate.

Preferably, the substrate is to be stored on a roll and is to be cut to size to individual dimensional requirements. Possible waste can advantageously be minimized in that large images or patterns in particular for flooring or graphic wall designs are distributed like a mosaic onto printed products of any small size and then joined to a complete image or pattern. If there is still a certain amount of waste, the possibly resulting material waste can be minimized by variable usability of the printed product. For example, it is in particular possible to use waste, produced e.g. by manufacturing a large surface area graphic wall design, for manufacturing a subsequent order, for example, of small surface area mouse pads. In this way, it is possible to produce the printed product according to the invention without wasting material and thus at correspondingly reduced costs. Possibly still generated waste residuals, due to their recyclability, can be returned into the material cycle so that environmental loading is completely minimized.

According to an alternative embodiment of the invention, the substrate is printed and the resulting printed product is subsequently cut to the desired shape. This is in particular advantageous for large surface area patterns or images because they can be continuously printed without the substrate having to be exchanged; thus, manufacture is advantageously simplified.

According to a preferred embodiment of the invention, the substrate or the printed product can be cut to any desired shape so that the printed product therefore is embodied to be designed in an individualized shape. Preferably, substrate or printed product can be cut to a rectangular, round, or individually desired free-form shape. In this way, it is possible to enhance the effect of the printed pattern or image on the printed product by an appropriate shaping. In this context, shapes of any kind, in particular in the form of stylized animals, sports equipment, foods, and the like are conceivable.

According to a preferred feature of the invention, the joined substrate that has been provided with a relief structure is supplied to a printing device and is printed with a predetermined quantity of color medium per square meter. Preferably, in a simple way a conventional printing device can be used for printing plastic films. The need for a special printing device is thus eliminated so that the production of the printed product as a whole is further simplified. The substrate according to the invention can be printed with any desired pattern or image in any desired color combination. The thus resulting possibilities are endless. In particular, the printed-on patterns or images can be scaled to size across the surface area without problem. This is achieved in particular in that the desired number of substrates are printed with portions of the complete image or pattern and, on site of use, are then combined to the complete image. In this way, comparatively large surfaces, in particular for advertising purposes, can be utilized uniformly. There is a demand in this regard particularly for the advertising-effective configuration of flooring and walls of exhibition halls, shopping centers, and the like. Moreover, comparatively small-sized substrates can be also printed in particular with individual images or patterns, for example, personal photos, artistic images and patterns, and the like. Advantageously, in this way mouse pads, table coverings, floor protection mats, in particular for desk chairs and sports equipment, as well as dartboards and counter tops of car dealerships, gas stations and the like can be matched individually to the respective customer's demands. Due to the free scaling option of the printed product, possible material loss for cutting to size can be minimized substantially.

All of the inventive and preferred features contribute in a synergistic way to providing a printed product whose field of use is independent of the supporting (mounting) surface, that is recyclable, and that has comparatively advantageous thermal properties and advantageous surface roughness on the user-side exterior face. Such printed products are in particular suitable when used as a table covering, mouse pad, wall covering, floor mat and the like for advertising purposes or also for producing individual wall or floor images or patterns of a large surface area.

### BRIEF DESCRIPTION OF THE DRAWING

The following embodiments serve only the purpose of explaining the invention and are not to be understood as being limiting.

FIG. 1 shows schematically, not to scale, a section illustration of a printed product according to the invention.

FIG. 2 shows schematically in a flow chart a preferred method for producing the printed product according to the invention.

### DESCRIPTION OF THE PREFERRED EMBODIMENTS

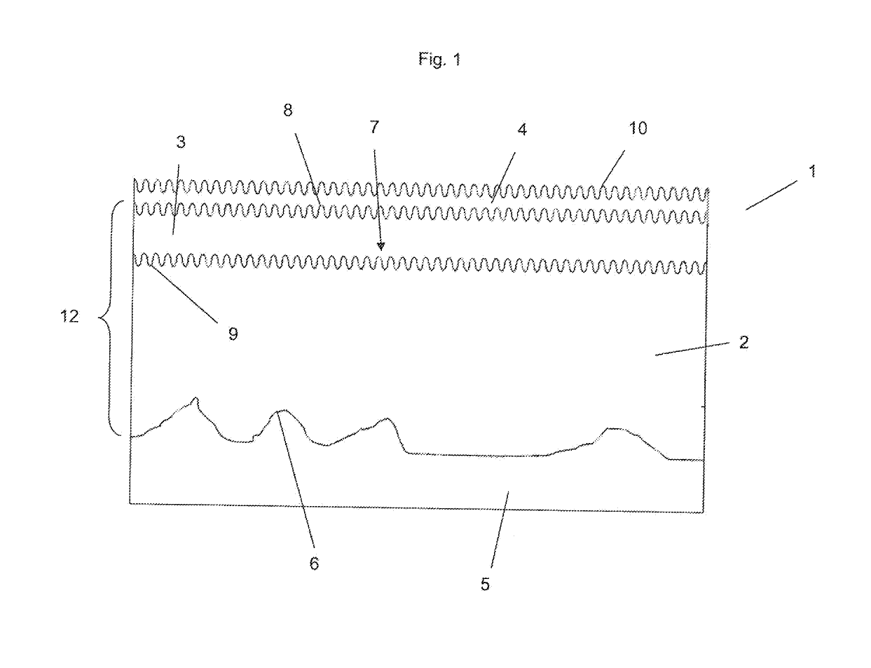

The printed product 1 according to FIG. 1 comprises a foamed, recyclable support 2, a plastic film 3, and a printed layer 4. It is positioned on a non-uniform supporting (mounting) surface 5.

The printed product 1 is simply placed onto the supporting (mounting) surface 5. An additional connection between the printed product 1 and the supporting (mounting) surface 5 is not provided. The printed product 1 is arranged on the supporting (mounting) surface 5 so as not to slip and slide due to the support 2. Due to the foamed, flexible configuration of the support 2, the unevenness 6 in the supporting (mounting) surface 5 are compensated and the thin plastic film 3 arranged on top is shielded from such unevenness 6 which otherwise would lead to destruction of the plastic film 3 and of the printed layer 4. The support 2 has for this purpose a material thickness of 1.8 mm and is comprised at least partially of polyvinyl chloride.

In the present case, the plastic film 3 is welded or fused to the support 2 with its surface 7 that is facing the support 2. According to an optional configuration, the plastic film 3 can be additionally provided at the face facing the support with a layer of glass fiber nonwoven for increasing the mechanical and thermal stability. The plastic film 3 is comprised presently also at least partially of polyvinyl chloride and has a material thickness of 0.2 mm.

The surface 8 of the plastic film 3 which is facing the printed layer 4 as well as the surface 9 of the support 2 facing the plastic film 3 are designed with a relief structure so that in combination with the color medium quantity of the printed layer 4 a desired surface roughness of 10 μm is achieved at the side of use.

In the present case, the printed layer 4 is printed onto the plastic film 3 by applying a UV-curable color medium in a quantity of 10 ml/m² to 15 ml/m², particularly 10 ml/m². In this way, the desired surface roughness can be achieved as well as, in connection with the mechanical and chemical properties of the support 2 and of the plastic film 3, a maximum heat quantity of 480 kJ per minute can be absorbed. The printed layer 4 forms presently the exterior side 10 of the printed product 1 which is the side of use. This side of use is directly in contact with the environment.

In contrast to the prior art printed products, the printed product 1 as described in this embodiment is usable in a plurality of applications in which the printed product is required to be arranged on technically complex supporting (mounting) surfaces, to have certain surface properties, and to have a certain degree of thermal absorption.

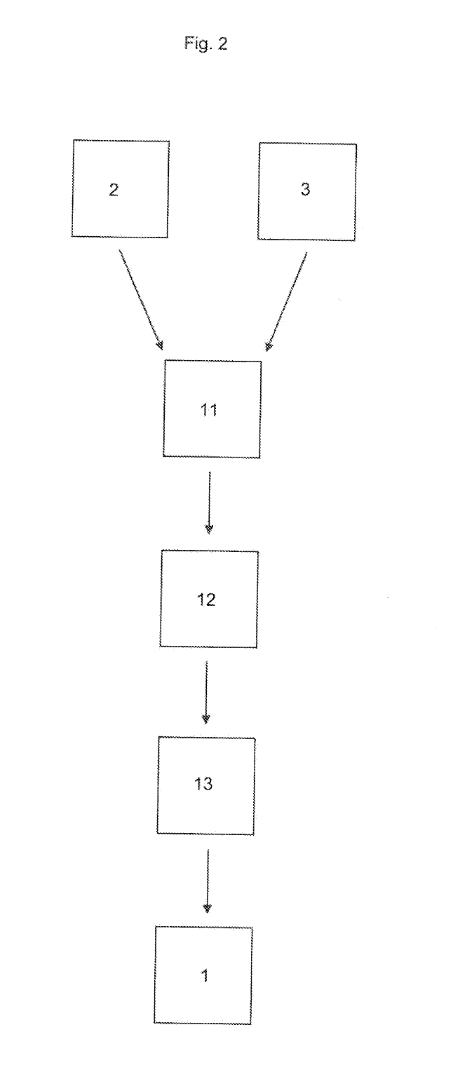

FIG. 2 shows in an exemplary fashion the method of manufacturing a printed product 1 of the invention.

The starting materials are in this context a plastic film 3 which is stored on a roll and a support 2 which is also stored on a roll. In a first step, the support 2 and the plastic film 3 are fused (welded) flat onto each other by means of pressure application across their facing sides to form a substrate 11. Advantageously, this connection is mechanically particularly stable so that delamination (separation) of the layers 2, 3 is effectively prevented. Moreover, the manufacturing process is simplified because in particular the need for an additional adhesive layer is advantageously eliminated.

In the same method step, the substrate 11 is provided, by embossment with pressure application, with a regularly distributed relief structure at the printing layer side of the printed product. As a result of this, the plastic film 3 and the support 2 have a relief structure. The height difference of the relief structure is dimensioned such that the printed product 1 after printing of the substrate 11 has a surface roughness of at least 10 μm at the printed layer side of the printed product 1 so that the printed product 1 is provided with advantageous adhesive properties.

After embossment, the substrate 12, now provided with a relief structure, can preferably be stored intermediately on a roll or can be directly provided with the printed layer 4. For this purpose, the relief-structured substrate 12 is fed to a conventional printer and is printed with a UV-curable color medium. The UV-curable color medium ensures advantageously a fast drying action, excellent printing quality, and comparatively high wear resistance. The quantity of the employed color medium is selected in this context such that a surface roughness of 10 μm and a maximally absorbable heat quantity of 480 kJ per minute and per square meter can be achieved without compromising or reducing the print quality. In the present case, the UV-curable color medium is printed with a quantity of 10 ml/m² onto the relief-structured substrate 12.

After printing and subsequent drying, the printed substrate 13 is cut to the desired shape, in the present case a rectangle, for forming the printed product 1. The printed product can now be used. Optionally, the printed layer 4 of the printed product 1, prior to cutting the printed substrate to size, can be sealed with a transparent layer of in particular a polyurethane resin in order to further increase the wear resistance.

The specification incorporates by reference the entire disclosure of European priority document 14 169 903.3 having a filing date of May 26, 2014.

While specific embodiments of the invention have been shown and described in detail to illustrate the inventive principles, it will be understood that the invention may be embodied otherwise without departing from such principles.

### LIST OF REFERENCE NUMERALS

1 printed product
2 support
3 plastic film
4 printed layer
5 supporting (mounting) surface
6 unevenness
7 surface of the plastic film facing the support
8 surface of the plastic film facing the printed layer
9 surface of the support facing the plastic film
10 exterior side of the printed product
11 substrate
12 relief-structured substrate
13 printed substrate

What is claimed is:

1. A printed product comprising:
a plastic film comprised of a first polymer composition, the first polymer composition at least partially comprising polyvinyl chloride or polyolefin, wherein the plastic film comprises a first face and an opposed second face;
a printed layer comprised of at least one color medium printed onto the first face of the plastic film, wherein the printed layer is configured to be sealant-free and forms a user-side exterior face of the printed product;
a support, wherein the second face of the plastic film is connected by material fusion to the support so as to form a substrate, wherein the support has a material thickness of at least 1.5 mm and is comprised at least partially of a foamed and recyclable second polymer composition;
wherein the printed layer is printed onto the plastic film in a quantity of 5 ml/m² to 40 ml/m² of the at least one color medium;
wherein the printed product has a surface roughness of at least 10 μm at the printed side where the printed layer is provided.

2. The printed product according to claim 1, wherein the support has a material thickness of 1.6 mm to 2.0 mm.

3. The printed product according to claim 1, wherein the plastic film is comprised of a first layer and a second layer, wherein the first layer is facing the support and the first layer is comprised of a glass fiber nonwoven.

4. The printed product according to claim 1, wherein the plastic film has a material thickness of 0.1 mm to 0.4 mm.

5. The printed product according to claim 1, wherein the color medium is UV-curable and wherein the quantity of the color medium printed onto the plastic film is 10 ml/m² to 15 ml/m².

6. The printed product according to claim 1, wherein the surface roughness is in a range from 10 μm to 30 μm.

7. The printed product according to claim 1, comprising a maximally absorbable heat quantity of at least 270 kJ per square meter per minute.

8. The printed product according to claim 7, wherein the maximally absorbable heat quantity is at least 480 kJ per square meter per minute.

9. The printed product according to claim 1 as a floor covering.

10. The printed product according to claim 1 as a wall covering.

11. The printed product according to claim 1 as a table covering.

12. A method for manufacturing a printed product according to claim 1, comprising:
removing a plastic film from a roll on which the plastic film is stored;
removing a support from a roll on which the support is stored;
joining by material fusion the plastic film and the support flat onto each other across their facing sides to form a substrate;
embossing a relief structure into the substrate;
printing a printed layer onto the plastic film of the substrate with at least one color medium applied in a quantity of 5 ml/m² to 40 ml/m² and adjusting the quantity of the at least one color medium such that the printed product has a surface roughness of at least 10 μm at the printed side where the printed layer is provided.

13. A method for manufacturing a substrate for a printed product according to claim 1, comprising:
removing a plastic film from a roll on which the plastic film is stored;
removing a support from a roll on which the support is stored;
joining by material fusion the plastic film and the support flat onto each other across their facing sides to form a substrate;
embossing a relief structure into the substrate.
